(19) United States
(12) Patent Application Publication
(10) Pub. No.: US 2018/0374042 A1
(43) Pub. Date: Dec. 27, 2018

(54) AGRICULTURAL PRODUCTION INFORMATION MANAGEMENT SYSTEM, SERVER DEVICE, AND PROGRAM FOR AGRICULTURAL PRODUCTION INFORMATION MANAGEMENT

(71) Applicant: Farm Alliance Management Co., Ltd., Tokyo (JP)

(72) Inventor: Takeshi Matsumoto, Tokyo (JP)

(21) Appl. No.: 16/117,038

(22) Filed: Aug. 30, 2018

Related U.S. Application Data
(62) Division of application No. 14/888,103, filed on Oct. 30, 2015.

(51) Int. Cl. G06Q 10/08; G06Q 30/02; G06Q 10/06; G06Q 50/02

(52) U.S. Cl. CPC G06Q 10/0835; G06Q 30/0202; G06Q 50/02; G06Q 10/0631

(57) ABSTRACT

The present invention is provided with: a shipment amount predicting unit 16 for calculating, every field, predicted shipment amounts at respective shipment times in future based on the shipment plan data and the shipping actual result data stored in the database 11; an insufficiency situation predicting unit 17 for predicting an insufficiency situation such as which field, which shipment time and what amount of insufficiency of the agricultural product based on the calculated predicted shipment amounts at respective shipment times in future and the planned shipment amounts at respective shipment times in future; and an insufficiency situation notifying unit 18 for transmitting, to the demander terminal 2, predicted data on the insufficiency situation, thereby performing notification. When shipping actual results in the middle of a certain period (for example, throughout a year) including a plurality of shipment times (for example, monthly shipment times) are registered in the database 11 for a shipment plan in the certain period, an insufficiency situation such as which field, which shipment time and what amount of the insufficiency of the agricultural product is subsequently calculated predictively and the demander terminal 2 is notified of a result thereof.

### TECHNICAL FIELD

The present invention relates to an agricultural production information management system, a server device and a program for agricultural production information management, and more particularly to a system configured to enable connection of a producer terminal to be used by a producer of an agricultural product in each field, a demander terminal to be used by a demander of the agricultural product and a server device through internet.

### BACKGROUND ART

Conventionally, there is proposed a system for supporting agriculture by using a computer (for example, see Patent Documents 1 to 3). The Patent Document 1 discloses a system for efficiently managing and inquiring traceability information about a producer of an agricultural product, a cultivation history or the like by utilizing a binding tape with a two-dimensional bar code or the like. In the system described in the Patent Document 1, a retailer terminal is configured to receive a browsing request of the traceability information including a production history reference number from a user terminal of a purchaser possessing a receipt, and reading traceability information corresponding to the production history reference number from a storage device and returning the traceability information to the user terminal.

Moreover, the Patent Document 2 discloses a system for supporting agricultural management of a farmer. The system described in the Patent Document 2 inputs agricultural work diary data including a work content, a work amount and a work occurrence date and time which are charged for each farm product, agricultural expense data including a charged expense and an expense occurrence date and time, and agricultural sales data including collected sales and a sales occurrence date and time and forms them into a database. By referring to the database, a work labor is calculated, an expense is calculated and sales are calculated for each agricultural product, and they are visualized and displayed for easy understanding.

Moreover, the Patent Document 3 discloses an agricultural product supply and demand management system for keeping a supply and demand balance between a supplier and a demander of an agricultural product and a processed food ordering/order receiving system for offering, to an orderer, a processed food using an agricultural product produced in a production area (an agricultural land) or by a producer desired through the orderer. The agricultural product supply and demand management system described in the Patent Document 3 has a production information database recording production information about an agricultural product and a demand information database recording demand information about the agricultural product, and calculates a predictive value of the lowest production amount of each agricultural product in each agricultural land at each time based on the production information. Based on the predictive value, supply and distribution of an agricultural product to a demander is determined for each type, breed and supply enabling time of an agricultural product.

Patent Document 1: Japanese Laid-Open Patent Publication No. 2009-151668

Patent Document 2: Japanese Laid-Open Patent Publication No. 2010-257353

Patent Document 3: Japanese Laid-Open Patent Publication No. 2005-151851

### DISCLOSURE OF THE INVENTION

In general, a farmer forms annual production and shipment plans for an agricultural product and performs a daily agricultural work to be adapted to the plans. However, a growth situation of the agricultural product greatly depends on a weather condition and an agricultural product cannot always be produced and shipped in a planned amount at a planned time. Usually, a price is increased when actual results are smaller than a plan so that insufficient supply to a market occurs, and the price is decreased when the actual results are greater than the plan so that excess supply occurs.

Referring to the system described in the Patent Document 3, the smallest production amount and a production time of the agricultural product are predicted to determine supply distribution to a demander. However, the prediction really does not carry. For this reason, demanders such as a wholesaler and a retailer cannot previously grasp when and what amount for insufficiency of the agricultural product. As a result, they are often swayed by an actual price fluctuation. Although the demanders want to avoid a shortage of goods by stably supplying the agricultural product as greatly as possible, thereby preventing the price from being increased carelessly, there is a problem in that this cannot easily be implemented.

On the other hand, although a producer such as a farmer can grasp a discrepancy between a plan and actual results for a field managed by himself (herself) to some degree, he (she) realistically has no means for transmitting the fact to an outside. For this reason, the demander cannot previously predict how a production situation of an agricultural product in each field influences the whole market. Therefore, there is a problem in that it is hard to take proper countermeasures.

The present invention has been made to solve such a problem and has an object to enable a demander to previously grasp a situation of insufficiency of an agricultural product to be shipped from each field, thereby taking proper countermeasures.

In order to attain the object, in the present invention, predicted shipment amounts at respective shipment times in future which have shipment plans and no shipping actual results are calculated for each field based on shipment plan data and shipping actual result data stored in a database. Moreover, an insufficiency situation such as which field, which shipment time and what amount for insufficiency of an agricultural product is predicted based on the predicted shipment amounts at respective shipment times which are calculated and the planned shipment amount at each shipment time in future related to the shipment plan data, and data on the predicted insufficiency situation is transmitted to a demander terminal to perform notification.

According to the present embodiment having the structure described above, when shipping actual results in the middle of a certain period (for example, throughout a year) including a plurality of shipment times (for example, monthly shipment times) are registered in the database for a shipment plan in the certain period, an insufficiency situation such as which field, which shipment time and what amount of the insufficiency of the agricultural product is subsequently calculated predictively and the demander terminal is notified of a result thereof.

For this reason, a demander such as a wholesaler or a retailer can previously grasp which field, which shipment time and what insufficiency of an agricultural product. Consequently, the demander can take proper countermeasures, for example, arrangement to supply, from other fields, a necessary amount of an agricultural product causing a shortage at a certain time in a certain field, adjustment of sale for a final consumer, or the like.

### BRIEF DESCRIPTION OF THE DRAWINGS

FIG. 1 is a diagram showing an example of a whole structure of an agricultural production information management system according to the present embodiment.

FIG. 2 is a table showing a specific example of various information to be input to a producer terminal every time a producer performs an agricultural work.

FIG. 3 is a diagram showing a transition example of an operation screen for inputting various information to the producer terminal every time the producer performs the agricultural work.

FIG. 4 is a view showing an example of a browsing screen to be displayed on a consumer terminal.

FIG. 5 is a diagram showing an example of a functional structure related to a main part of a server device according to the present embodiment.

FIG. 6 is a table showing an example of shipment plan data on a certain agricultural product in two fields.

FIG. 7 is a table showing an example of shipping actual result data on the certain agricultural product in the two fields.

FIG. 8 is a table for explaining processing contents of a shipment amount predicting unit and an insufficiency situation predicting unit according to the present embodiment.

FIG. 9 is a chart for explaining the processing contents of the shipment amount predicting unit and the insufficiency situation predicting unit according to the present embodiment.

FIG. 10 is a view showing an example of a screen of a decision result at a shipment time to be displayed on a demander terminal.

### BEST MODE FOR CARRYING OUT THE INVENTION

An embodiment according to the present invention will be described below with reference to the drawings. FIG. 1 is a diagram showing an example of a whole structure of an agricultural production information management system according to the present embodiment. As shown in FIG. 1, the agricultural production information management system according to the present embodiment includes a producer terminal 1 to be used by a producer of an agricultural product in each field, a demander terminal 2 to be used by a demander (a wholesaler, a retailer or the like) of an agricultural product, a consumer terminal 3 to be used by a final consumer of an agricultural product, and a server device 4.

The producer terminal 1, the demander terminal 2 and the consumer terminal 3 can be configured from a terminal such as a personal computer, a tablet or a smartphone, for example. The consumer terminal 3 may be a terminal which is installed in a retail store or the like and can be freely used by a final consumer. The producer terminal 1, the demander terminal 2 and the consumer terminal 3 are configured to be connectable to the server device 4 through internet 10.

In the producer terminal 1 of each field, a producer inputs shipment plan data on a shipment time and a shipment amount of an agricultural product and transmits the data to the server device 4 through the internet 10. For example, a plan related to a monthly shipment amount is formed at a time that production of an agricultural product is started, and is input, to the producer terminal 1, as shipment plan data on a planned shipment amount for each shipment time (monthly) and the shipment plan data is transmitted to the server device 4 through the internet 10.

In the producer terminal 1 of each field, moreover, the producer inputs shipping actual result data on the shipment time and the shipment amount of the agricultural product at any time and transmits the shipping actual result data to the server device 4 through the internet 10. For example, when actually harvesting and shipping the agricultural product, the producer inputs a monthly actual result shipment amount as the shipment actual result data to the producer terminal 1 and transmits the shipping actual result data to the server device 4 through the internet 10.

In the producer terminal 1 of each field, furthermore, a producer of an agricultural product inputs agricultural work report data including a work day, a work content, a predicted shipment time and a predicted shipment amount at any time and transmits the agricultural work report data to the server device 4 through the internet 10. Every time the producer actually performs some work, the work day and the work content are input to the producer terminal 1 and transmitted to the server device 4 through the internet 10.

Although the input to the producer terminal 1 is performed for each work, the transmission to the server device 4 may be collectively carried out corresponding to a certain period. Moreover, it is not necessary to always input the predicted shipment time and the predicted shipment amount every work but it is sufficient to input them in an optional timing. Referring to the predicted shipment time and the predicted shipment amount, furthermore, the producer inputs a shipment time and a shipment amount predicted in accordance with a rule of thumb or the like in consideration of a growth situation of an agricultural product, a weather condition of that year or the like.

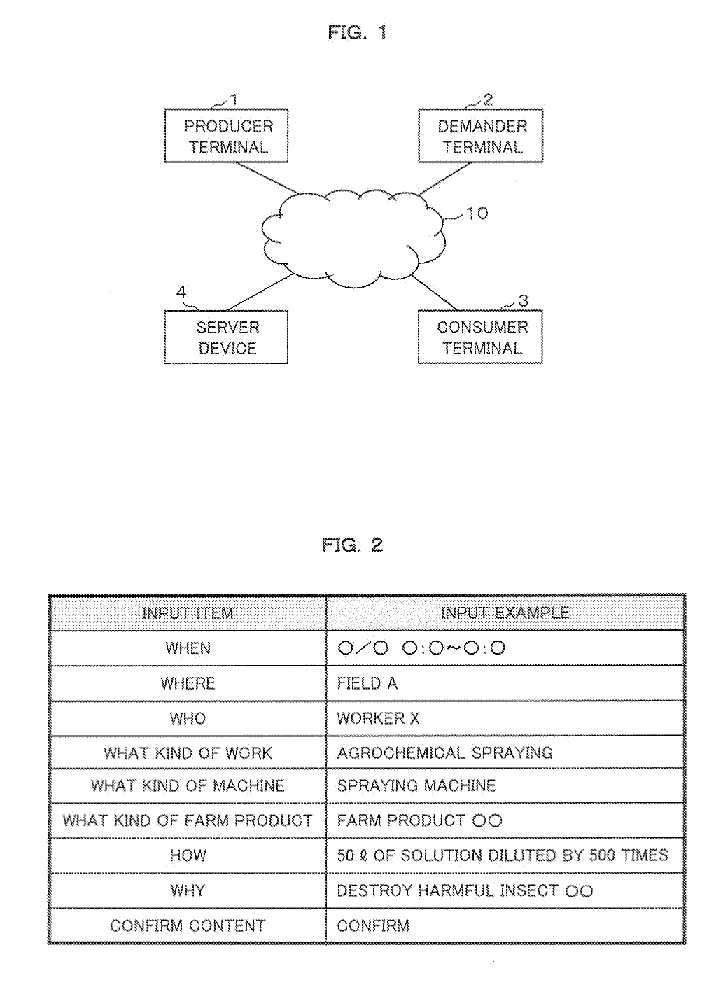

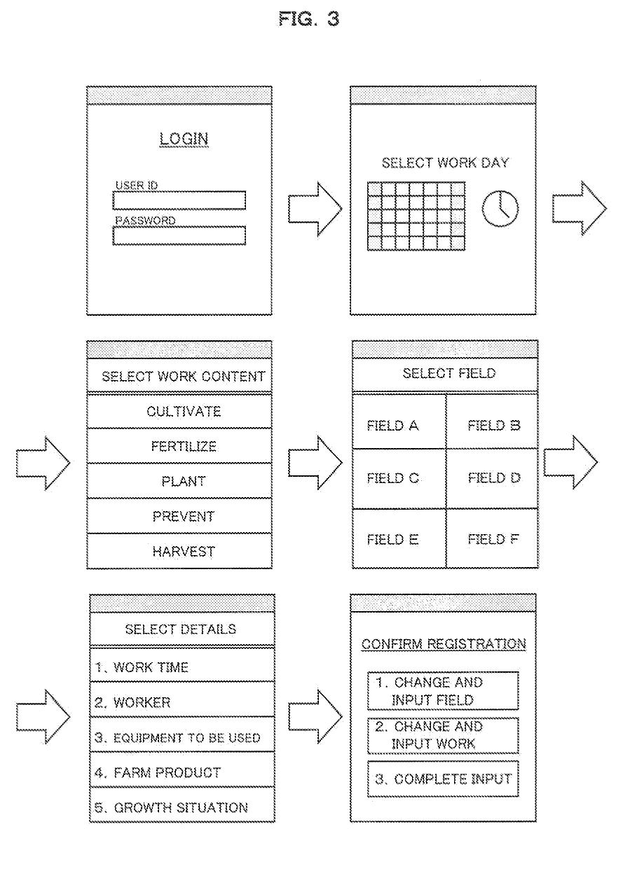

FIG. 2 is a table showing a specific example of various information to be input to the producer terminal 1 every time the producer performs the agricultural work. Moreover, FIG. 3 is a diagram showing a transition example (a part) of an operation screen for inputting these information. In the present embodiment, information can be input by an ATM (automatic teller machine) system using a touch panel. The producer can sequentially input necessary agricultural work report data by a simple operation for simply making a touch in accordance with an instruction of the screen.

When inputting data on a shipment (a harvest) as one of the agricultural work report data, the producer issues a product label having an identification number allocated every field through a bar code, a two-dimensional code or the like and attaches the product label to a packaging material for an agricultural product to be shipped. Then, association information of the identification number with the field is input in the producer terminal 1 and is transmitted to the server device 4.

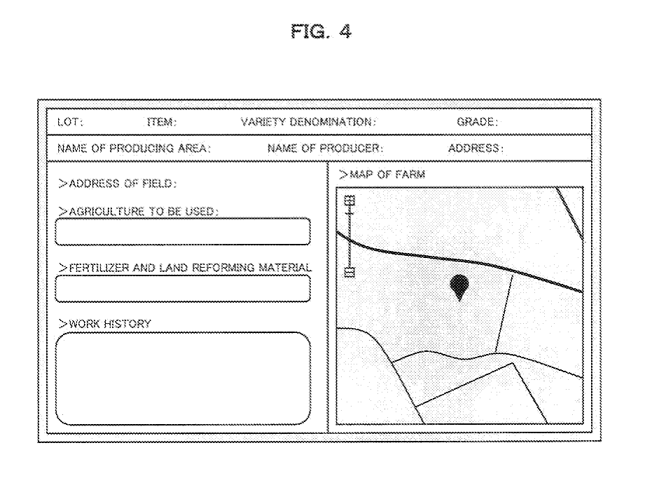

The final consumer of the agricultural product accesses a portal site to be offered from the consumer terminal 3 by the server device 4, inputs, from the consumer terminal 3, an identification number given to a product label attached to a packaging material for a purchased agricultural product and transmits the identification number to the server device 4, thereby enabling browsing of a producer name, a contact address and a serial process of an agricultural work from seeding to harvesting. By associating an identification number with position information about a field, furthermore, it is also possible to display a position of the field on a map. FIG. 4 is a view showing an example of a browsing screen to be displayed on the consumer terminal 3.

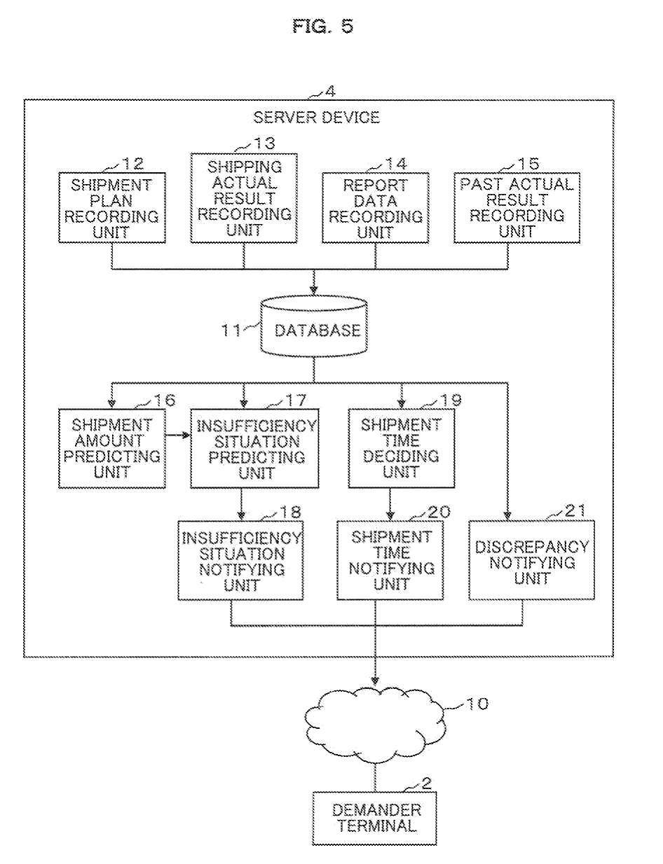

FIG. 5 is a diagram showing an example of a functional structure related to a main part of the server device 4 according to the present embodiment. As shown in FIG. 5, the server device 4 according to the present embodiment includes, as the functional structure, a database 11, a shipment plan recording unit 12, a shipping actual result recording unit 13, a report data recording unit 14, a past actual result recording unit 15, a shipment amount predicting unit 16, an insufficiency situation predicting unit 17, an insufficiency situation notifying unit 18, a shipment time deciding unit 19, a shipment time notifying unit 20 and a discrepancy notifying unit 21.

The respective function blocks 11 to 21 can be configured from all of hardware, a DSP (Digital Signal Processor) and software. For example, if the respective function blocks 11 to 21 are configured from the software, they actually include a CPU, an RAM, an ROM and the like in a computer and are implemented by an operation of a program for agricultural production information management stored in a recording medium such as the RAM, the ROM, a hard disk or a semiconductor memory.

Accordingly, the functions of the function blocks 11 to 21 can be implemented by recording the program for agricultural production information management in a recording medium such as a CD-ROM and causing a computer to read the program. As the recording medium recording the program for agricultural production information management, it is possible to use a flexible disk, a hard disk, a magnetic tape, an optical disk, a magneto-optical disk, a DVD, a nonvolatile memory card and the like in addition to the CD-ROM. Moreover, the functions can also be implemented by downloading the program for agricultural production information management into a computer through a network such as the internet 10.

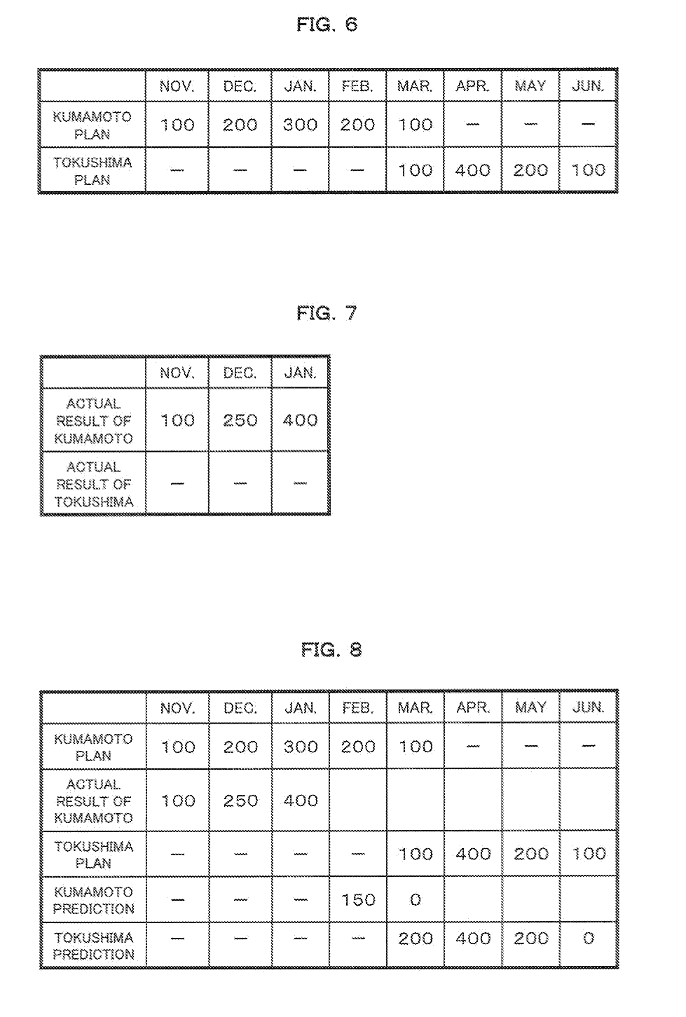

The shipment plan recording unit 12 receives shipment plan data on a shipment time and a planned shipment amount of an agricultural product input every field in the producer terminal 1 of each field and stores them in the database 11. FIG. 6 is a table showing an example of shipment plan data on a certain agricultural product in two fields (Kumamoto and Tokushima). In an example of FIG. 6, in the field of Kumamoto (hereinafter referred to as an agricultural product grown in Kumamoto), there are planned shipment amounts of 100 tons in November, 200 tons in December, 300 tons in January, 200 tons in February and 100 tons in March. On the other hand, in the field of Tokushima (hereinafter referred to as an agricultural product grown in Tokushima), there are planned shipment amounts of 100 tons in March, 400 tons in April, 200 tons in May and 100 tons in June.

The shipping actual result recording unit 13 receives shipping actual result data on the shipment time and the actual result shipment amount of the agricultural product input every field in the producer terminal 1 for each field and stores them in the database 11 at any time. FIG. 7 is a table showing an example of shipping actual result data on a certain agricultural product in the two fields (Kumamoto and Tokushima). An example of FIG. 7 shows shipping actual result data as of January. The agricultural product grown in Kumamoto is shipped as actual results of 100 tons in November, 250 tons in December and 400 tons in January. There is no actual result of a shipment of the agricultural product grown in Tokushima.

The report data recording unit 14 receives agricultural work report data including the work day, the work content (the various information shown in FIG. 2), the predicted shipment time and the predicted shipment amount input at any time every field in the producer terminal 1 of each field and stores them in the database 11 at any time.

The past actual result recording unit 15 associates transitions of an atmospheric temperature and a rainfall in the past in each field with a shipment time and a shipment amount of an agricultural product in the past in each field and stores them as past actual result data in the database 11. Data on the past transitions of the atmospheric temperature and rainfall are not input from the producer terminal 1 by the producer but are input by an operator of the server device 4 through purchasing from an outside or the like. On the other hand, data on the shipment time and shipment amount in the past are input from the producer terminal 1 by the producer in the past. The operator of the server device 4 performs the association of these data by using an operating unit of the server device 4 which is not shown.

The shipment amount predicting unit 16 calculates predicted shipment amounts at respective shipment times in future which have shipment plans and no shipping actual results every field based on the shipment plan data stored in the database 11 by the shipment plan recording unit 12 and the shipping actual result data stored in the database 11 by the shipping actual result recording unit 13.

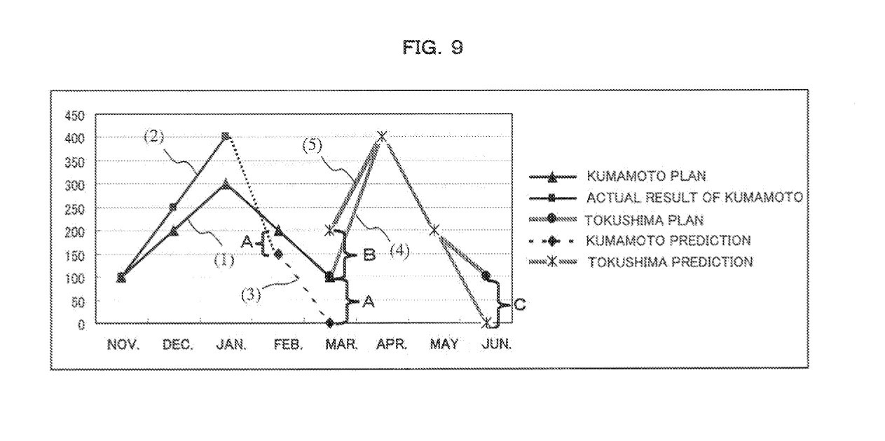

FIGS. 8 and 9 are a table and a chart for explaining processing contents of the shipment amount predicting unit 16 and the insufficiency situation predicting unit 17, respectively. In FIG. 8, the shipment plan data and the shipping actual result data on the agricultural product grown in Kumamoto and the shipment plan data on the agricultural product grown in Tokushima are shown in FIGS. 6 and 7, respectively. On the other hand, referring to the agricultural product grown in Kumamoto, the shipment amount predicting unit 16 predicts that the shipment amount in February is 150 tons and the shipment amount in March is 0 ton. This is obtained by the following calculation.

In other words, a total planned shipment amount obtained by totalizing the planned shipment amounts for respective shipment times (November to March) related to the shipment plan data on the agricultural product grown in Kumamoto is 900 tons. Moreover, an accumulated actual result shipment amount obtained by accumulating the actual result shipment amounts for the respective shipment times (November to January) related to the shipping actual result data on the agricultural product grown in Kumamoto is 750 tons. Accordingly, a shipment amount to be their difference is 150 tons.

In this case, the shipment amount predicting unit 16 calculates predicted shipment amounts at respective shipment times in future based on the shipment amount to be the difference calculated as described above and planned shipment amounts at respective shipment times (February and March) in future which have shipment plans and no shipping actual results. Specifically, the shipment amount predicting unit 16 calculates a predicted shipment amount in such a manner that the shipment amount to be the difference is allocated to approach the shipment plan as greatly as possible.

In other words, the shipment amount predicting unit 16 first predicts the shipment amount for February. Here, 750 tons have already been shipped as actual results with respect to 900 tons of a plan at a termination time point of January. For this reason, only 150 tons are left. Since 150 tons are smaller than 200 tons of the planned shipment amount in February, they are wholly set to be a predicted shipment amount in February. Accordingly, a predicted shipment amount in March is necessarily 0 ton.

The insufficiency situation predicting unit 17 predicts an insufficiency situation as to which field, which shipment time and what amount for insufficiency of an agricultural product based on predicted shipment amounts at respective shipment times in future calculated by the shipment amount predicting unit 16 (150 tons in February and 0 ton in March for the agricultural product grown in Kumamoto in the example of FIG. 8) and planned shipment amounts at respective shipment times in future related to the shipment plan data stored in the database 11 (200 tons in February and 100 tons in March for the agricultural product grown in Kumamoto). In the example of FIG. 8, it is predicted that the agricultural product grown in Kumamoto is insufficient in the amounts of 50 tons and 100 tons in February and March, respectively.

In a graph shown in FIG. 9, (1) indicates planned shipment amounts in November to March related to the agricultural product grown in Kumamoto, (2) indicates actual result shipment amounts in November to January related to the agricultural product grown in Kumamoto, and (3) indicates predicted shipment amounts in February and March related to the agricultural product grown in Kumamoto. The actual results of the agricultural product grown in Kumamoto make a transition with a plan exceeded. For this reason, the insufficiency situation predicting unit 17 predicts that a shortage of goods is caused in 500 tons as of February and 100 tons as of March for the agricultural product grown in Kumamoto as shown in a point A.

When the actual results of the shipment amount make the transition with the plan exceeded as described above, there is increased a possibility that the shortage of goods might be caused subsequently. Therefore, the shipment amount predicting unit 16 preferably calculates a predicted shipment amount if a difference between the accumulated planned shipment amount obtained by accumulating the planned shipment amounts for the respective shipment times related to the shipment plan data stored in the database 11 and the accumulated actual result shipment amounts obtained by accumulating the actual result shipment amounts for the respective shipment times related to the shipping actual result data stored in the database 11 is equal to or greater than a predetermined data size.

In the example of FIG. 8, if the accumulated actual result shipment amount is larger than the accumulated planned shipment amount by 20% or more, the predicted shipment amount is calculated. In other words, since the accumulated planned shipment amount is 100 tons and the accumulated actual result shipment amount is 100 tons as of November, both of them have no difference. Accordingly, the shipment amount predicting unit 16 has not calculated the predicted shipment amount yet on this time point.

Since the accumulated planned shipment amount is 300 tons and the accumulated actual result shipment amount is 350 tons as of December, moreover, the accumulated actual result shipment amount is merely larger than the accumulated planned shipment amount by 16.7% though the actual results exceed the plan. Accordingly, the shipment amount predicting unit 16 has not calculated the predicted shipment amount yet on this time point.

When January comes, then, the accumulated planned shipment amount is 600 tons and the accumulated actual result shipment amount is 750 tons. For this reason, the accumulated actual result shipment amount is larger than the accumulated planned shipment amount by 25%. Accordingly, the shipment amount predicting unit 16 calculates the predicted shipment amount on this time point. The result of the calculation is shown in FIGS. 8 and 9.

When a shortage of goods is caused in one field, a shipment in other fields is also influenced by supply of the shortage. FIGS. 8 and 9 show the examples in which a shortage of the agricultural product grown in Kumamoto is supplied by that in Tokushima. In the case in which a certain field supplies a shortage of goods in another field, there is a possibility that a shipment amount in the certain field might be insufficient from the beginning. In this case, accordingly, it is preferable to calculate the predicted shipment amount without depending on whether the accumulated actual result shipment amount is larger than the accumulated planned shipment amount by 20% or more.

In other words, the shipment amount predicting unit 16 calculates predicted shipment amounts at respective shipment times in future based on planned shipment amounts at respective shipment times related to shipment plan data of the agricultural product grown in Tokushima and an insufficient amount at a specific shipment time which is predicted by the insufficiency situation predicting unit 17 for the agricultural product grown in Kumamoto when a predicted shipment amount of the product grown in Tokushima to supply the shortage of the agricultural product grown in Kumamoto is to be calculated.

Specifically, the shipment amount predicting unit 16 calculates a predicted shipment amount in March as 200 tons (=100+100 tons) based on the planned shipment amount (100 tons) in March related to the shipment plan data on the agricultural product grown in Tokushima and an insufficient amount (100 tons) in March which is predicted by the insufficiency situation predicting unit 17 for the agricultural product grown in Kumamoto. Thereafter, it is predicted that the shipment can be carried out according to plans in April and May. However, a total planned shipment amount of the agricultural product grown in Tokushima is completely brought out on that time point. For this reason, a predicted shipment amount in June is 0 ton.

In this case, the insufficiency situation predicting unit 17 predicts that 100 tons of the agricultural product grown in Tokushima are insufficient in June based on a predicted shipment amount in June which is calculated by the shipment amount predicting unit 16 (0 ton of the agricultural product grown in Tokushima) and a planned shipment amount in June which is related to the shipment plan data stored in the database 11 (100 tons of the agricultural product grown in Tokushima).

In the graph shown in FIG. 9, (4) indicates planned shipment amounts in March to June related to the agricultural product grown in Tokushima and (5) indicates predicted shipment amounts in March to June related to the agricultural product grown in Tokushima. A point Bin this graph indicates that 100 tons of the agricultural product grown in Tokushima are required to supply an insufficient amount (A) of the agricultural product grown in Kumamoto in March. Moreover, the insufficiency situation predicting unit 17 predicts that a shortage of the agricultural product grown in Tokushima in the amount of 100 tons is caused as of June because the agricultural product grown in Tokushima is shipped more in an advancement of 100 tons in March as shown in a point C.

The insufficiency situation notifying unit 18 performs notification by transmitting data on the insufficiency situation predicted by the insufficiency situation predicting unit 17 to the demander terminal 2 through the internet 10. The notification may be carried out when a portal site offered from the demander terminal 2 by the server device 4 is accessed to give a request for dada acquisition.

The data on the insufficiency situation to be transmitted to the demander terminal 2 may be data on a shipment time and an insufficient amount in which a shortage of goods is predicted or data in the graph shown in FIG. 9. The demander terminal 2 displays, on a screen, data transmitted from the server device 4, thereby notifying a demander of which field, which shipment time and what shortage of goods to be caused.

The shipment time deciding unit 19 compares the predicted shipment time and the predicted shipment amount stored in the database 11 by the notification data recording unit 14 with the planned shipment time and the planned shipment amount related to the shipment plan data stored in the database 11 by the shipment plan recording unit 12 and decides whether the shipment can be performed according to the planned shipment time, whether the shipment can be performed earlier than the planned shipment time by a predetermined period or more and whether the shipment is performed later than the planned shipment time by a predetermined period or more.

As described above, the planned shipment time and the planned shipment amount are transmitted from the producer terminal 1 to the server 4 through formation of a plan related to a monthly shipment amount by a user at a time that the production of an agricultural product is started. On the other hand, the predicted shipment time and the predicted shipment amount are predicted from a growth situation of the agricultural product, a weather condition or the like at that time by the producer and are transmitted from the producer terminal 1 to the server device 4 in an optional timing from seeding to harvesting.

The shipment time deciding unit 19 decides that the shipment can be performed almost according to the plan if a difference between the predicted shipment time that the shipment can be performed in the same predicted shipment amount as the planned shipment amount and the planned shipment time is smaller than a predetermined period. Moreover, the shipment time deciding unit 19 decides that the shipment can be performed ahead of the plan if the predicted shipment time that the shipment can be performed in the same predicted shipment amount as the planned shipment amount is earlier than the planned shipment time by a predetermined period or more. Furthermore, the shipment time deciding unit 19 decides that the shipment is delayed from the plan if the predicted shipment time that the shipment can be performed in the same predicted shipment amount as the planned shipment amount is later than the planned shipment time by a predetermined period or more.

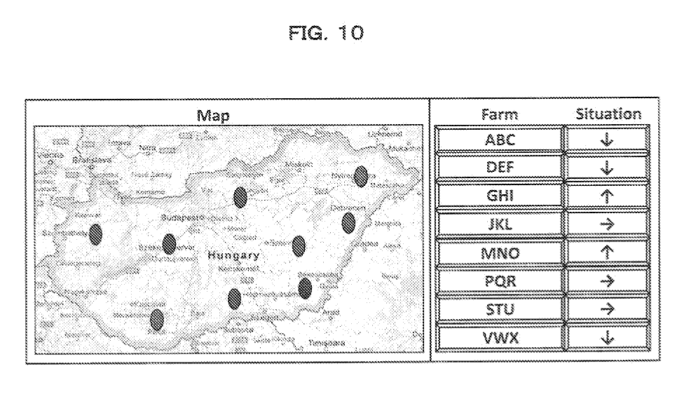

The shipment time notifying unit 20 transmits a result of the decision made by the shipment time deciding unit 19 to the demander terminal 2, thereby performing notification. FIG. 10 is a view showing an example of a screen of a decision result for the shipment time displayed on the demander terminal 2. In FIG. 10, a map is displayed on a left side of the screen and a position of each field is shown on the map. A result of decision for a shipment time in each field displayed on the map is displayed on a right side of the screen. Display of “↑” indicates that the shipment can be performed ahead of the plan, display of “→” indicates that the shipment can be performed according to the plan, and display of “↓” indicates that the shipment is performed later than the plan.

The demander browses an insufficiency situation of an agricultural product of which the demander terminal 2 is notified by the insufficiency situation notifying unit 18 (prediction information about which field, which shipment time and what insufficiency to be caused) and information about the shipment time of which the demander terminal 2 is notified by the shipment time notifying unit 20, thereby enabling proper countermeasures to be taken, for example, arrangement to supply an agricultural product to be brought into a shortage of goods at a certain time in a certain field in a necessary amount from another field in which the shipment can be performed ahead, for example, adjustment of sale for a final consumer, or the like.

Although the description has been given to the example in which the result of the decision for the shipment time made by the shipment time deciding unit 19 is transmitted to the demander terminal 2 to perform notification, the present invention is not restricted thereto. For example, by notifying the shipment amount predicting unit 16 of information about a field decided to enable the shipment ahead, the shipment amount predicting unit 16 may automatically specify another field for supplying a shortage of goods occurring in a certain field to calculate a predicted shipment amount in the another field.

Referring to the example of FIG. 8, if the shipment time deciding unit 19 decides that the agricultural product grown in Tokushima can be shipped ahead of the plan in a field, it notifies the shipment amount predicting unit 16 that the agricultural product grown in Tokushima can be shipped ahead. Upon receipt of the notification, the shipment amount predicting unit 16 confirms that the shipment of the agricultural product grown in Tokushima is planned after February in which a shortage of the agricultural product grown in Kumamoto is caused, and furthermore, specifies the agricultural product grown in Tokushima as a field for supplying the shortage of the agricultural product grown in Kumamoto and calculates the predicted shipment amount of the agricultural product grown in Tokushima as described above.

The discrepancy notifying unit 21 estimates a shipment time and a shipment amount of this year based on transitions of an atmospheric temperature and a rainfall of this year in each field and past actual result data stored in the database 11 by the past actual result recording unit 15 (data associating transitions of an atmospheric temperature and a rainfall in the past in each field with a shipment time and a shipment amount of an agricultural product).

In other words, the discrepancy notifying unit 21 extracts any of plural types of transitions of the atmospheric temperature and the rainfall indicated as the past actual result data which has the closest pattern to the transition of the atmospheric temperature and the transition of the rainfall of this year. The shipment time and the shipment amount associated with the transitions of the atmospheric temperature and the rainfall thus extracted are estimated as the shipment time and the shipment amount of this year.

Subsequently, the discrepancy notifying unit 21 compares an estimated shipment time and an estimated shipment amount of this year thus obtained with the predicted shipment time and the predicted shipment amount stored in the database 11 by the report data recording unit 14. If at least one of a discrepancy between the estimated shipment time and the predicted shipment time and a discrepancy between the estimated shipment amount and the predicted shipment amount is equal to or greater than a predetermined magnitude, the discrepancy notifying unit 21 transmits information for reporting that effect to the demander terminal 2, thereby performing notification.

In other words, since the predicted shipment time and the predicted shipment amount are input based on a rule of thumb of the producer or the like, they do not always have objectivity. Therefore, the discrepancy notifying unit 21 decides a magnitude of a discrepancy between a shipment time and a shipment amount which are objectively estimated from pattern matching utilizing a transition of an atmospheric temperature and a transition of a rainfall in the past actual result data, and a predicted shipment time and a predicted shipment amount in accordance with the rule of thumb of the producer or the like. If the discrepancy is equal to or greater than a predetermined magnitude, information about that effect is transmitted to the demander terminal 2 to perform notification.

Although the notification way in this case is optional, the notification indicates a probability of prediction through the producer. For this reason, it is preferable to perform the notification in such a manner as to easily know the probability. For example, it is also possible to display notification information about a discrepancy together with marks of “↑”, “→” and “↓” on a screen indicative of a result of decision related to the earliness of planned and predicted shipment times shown in FIG. 10. Thus, it is possible to notify the demander of the probability of the decision result itself related to the earliness or lateness of the shipment time.

As described above in detail, in the present embodiment, predicted shipment amounts at respective shipment times in future which have shipment plans and no shipping actual results are calculated for each field based on a total planned shipment amount obtained by totalizing a planned shipment amount for each shipment time related to shipment plan data and an accumulated actual result shipment amount obtained by accumulating actual result shipment amounts for respective shipment times related to the shipping actual result data. Moreover, an insufficiency situation such as which field, which shipment time and what amount for insufficiency of an agricultural product is predicted based on the predicted shipment amounts at respective shipment times which are calculated and the planned shipment amounts at respective shipment times in future related to the shipment plan data, and data on the predicted insufficiency situation is transmitted to the demander terminal 2 to perform notification.

According to the present embodiment having such a structure, when shipping actual results in the middle of a certain period are registered in the database 11 for a shipment plan in a certain period (for example, throughout a year) including a plurality of shipment times (for example, monthly shipment times), an insufficiency situation such as which field, which shipment time and what amount of the insufficiency of the agricultural product is subsequently calculated predictively and the demander terminal 2 is notified of a result thereof.

For this reason, a demander such as a wholesaler or a retailer can previously grasp which field, which shipment time and what insufficiency of an agricultural product. Consequently, the demander can take proper countermeasures, for example, arrangement to supply, from another field, a necessary amount of an agricultural product causing a shortage of goods at a certain time in a certain field, adjustment of sale for a final consumer, or the like.

In the present embodiment, moreover, the processings of the shipment amount predicting unit 16 and the insufficiency situation predicting unit 17 are executed if the difference between the accumulated planned shipment amount and the accumulated actual result shipment amount is equal to or greater than a predetermined magnitude. Thus, it is possible to previously predict the insufficiency situation of the agricultural product, thereby notifying the demander of the prediction in such a proper timing that the actual results of the shipment amount make a transition with the plan exceeded and a possibility of occurrence of a shortage of goods is thus increased.

In the present embodiment, moreover, when a shipment amount and an insufficiency situation in future in a certain field (for example, Tokushima) are to be predicted, an insufficient amount at a specific shipment time which is predicted for another field (for example, Kumamoto) is added to calculate predicted shipment amounts at respective shipment times in future.

Consequently, insufficiency situations of agricultural products in individual fields are not simply predicted separately but a whole (linked) insufficiency situation of the agricultural product to be shipped from each field can be predicted precisely. Consequently, the demander can take proper countermeasures while grasping a whole part.

In the present embodiment, moreover, the predicted shipment time and the predicted shipment amount input at any time every field in the producer terminal 1 of each field are compared with the planned shipment time and the planned shipment amount related to the shipped plan data and it is decided whether the shipment can be performed according to a plan, whether the shipment can be performed earlier than the plan by a predetermined period or more and whether the shipment is performed later than the plan by a predetermined period or more, and results of the decision are transmitted to the demander terminal 2 to perform notification. Consequently, the demander can take countermeasures such as selection of a field capable of performing the shipment ahead as another field for supplying an agricultural product causing a shortage in a certain field.

Although the description has been given to the example in which prediction related to two fields including Kumamoto and Tokushima is performed in the embodiment, the number of two is only illustrative for the description but the present invention is not restricted thereto. In the case in which prediction related to three or more fields is performed, the demander may optionally set which one of the other fields to supply a shortage of goods in a certain field by seeing the notification contents obtained by the insufficiency situation notifying unit 18 or the shipment time notifying unit 20.

Although the description has been given to the example in which the processing is carried out on a monthly unit in the embodiment, moreover, the unit is not restricted thereto. For example, the processing may be carried out on an optional unit in accordance with an agricultural product, for example, a weekly unit or a daily unit.

Although only the insufficient amount of the agricultural product grown in Kumamoto in March in which the shipment plan of the agricultural product grown in Tokushima is started is added to calculate, as 200 tons (=100+100 tons), the predicted shipment amount in March of the agricultural product grown in Tokushima in the example of FIG. 8 in the embodiment, furthermore, the present invention is not restricted thereto. For example, the insufficient amount of the agricultural product grown in Kumamoto in February before March in which the shipment plan for the agricultural product grown in Tokushima is started may be further added to calculate, as 250 tons, the predicted shipment amount in March of the agricultural product grown in Tokushima.

In addition, the embodiment is only illustrative for concreteness to carry out the present invention and the technical scope of the present invention should not be thereby construed to be restrictive. In other words, the present invention can be carried out in various configurations without departing from the gist or main features thereof.

1-8. (canceled)

9. A server device configured to enable connection to a producer terminal to be used by a producer of an agricultural product in each field and a demander terminal to be used by a demander of the agricultural product through internet, the server device comprising:
a shipment plan recording unit for receiving shipment plan data on a shipment time and a planned shipment amount of an agricultural product input every field in the producer terminal of the each field and storing the shipment plan data in a database;
a report data recording unit for receiving agricultural work report data including a work day, a work content, a predicted shipment time and a predicted shipment amount input at any time every field in the producer terminal of the each field, and storing the agricultural work report data in the database at any time;
a shipment time deciding unit for comparing the predicted shipment time and the predicted shipment amount stored in the database by the report data recording unit with the shipment time and the planned shipment amount related to the shipment plan data stored in the database by the shipment plan recording unit and deciding whether shipment can be performed according to the shipment time related to the shipment plan data, whether the shipment can be performed earlier than the shipment time related to the shipment plan data by a predetermined period or more, and whether the shipment is performed later than the shipment time related to the shipment plan data by a predetermined period or more; and
a shipment time notifying unit for transmitting a result obtained by the decision of the shipment time deciding unit to the demander terminal, thereby performing notification.

10-11. (canceled)

12. A program for agricultural production information management which is to be operated in a server device configured to enable connection to a producer terminal to be used by a producer of an agricultural product in each field and a demander terminal to be used by a demander of the agricultural product through internet and serves to cause a computer to function as:
shipment plan recording means for receiving shipment plan data on a shipment time and a planned shipment amount of an agricultural product input every field in the producer terminal of the each field and storing the shipment plan data in a database;
report data recording means for receiving agricultural work report data including a work day, a work content, a predicted shipment time and a predicted shipment amount input at any time every field in the producer terminal of the each field, and storing the agricultural work report data in the database at any time;
shipment time deciding means for comparing the predicted shipment time and the predicted shipment amount stored in the database by the report data recording means with the shipment time and the planned shipment amount related to the shipment plan data stored in the database by the shipment plan recording means and deciding whether shipment can be performed according to the shipment time related to the shipment plan data, whether the shipment can be performed earlier than the shipment time related to the shipment plan data by a predetermined period or more, and whether the shipment is performed later than the shipment time related to the shipment plan data by a predetermined period or more; and
shipment time notifying means for transmitting a result obtained by the decision of the shipment time deciding means to the demander terminal, thereby performing notification.
